(19) United States
(12) Patent Application Publication
(10) Pub. No.: US 2020/0331461 A1
(43) Pub. Date: Oct. 22, 2020

(54) VEHICLE SYSTEM

(71) Applicant: Mazda Motor Corporation, Hiroshima (JP)

(72) Inventors: Yasumasa Imamura, Aki-gun (JP); Taku Yoshida, Aki-gun (JP); Daisuke Umetsu, Aki-gun (JP)

(21) Appl. No.: 16/839,323

(22) Filed: Apr. 3, 2020

(30) Foreign Application Priority Data
Apr. 22, 2019 (JP) 2019-080755

(51) Int. Cl. B60W 30/045; B60K 23/08; B60W 10/119; B60W 10/184

(52) U.S. Cl. CPC B60W 30/045; B60K 23/0808; B60K 17/34; B60W 10/184; B60W 10/119

(57) ABSTRACT

A vehicle system includes a drive source configured to generate torque for driving a vehicle, wheels including rear wheels that are primary driving wheels and front wheels that are auxiliary driving wheels, a torque distribution mechanism configured to distribute the torque of the drive source to the front wheels and the rear wheels, a steering wheel configured to be operated by a driver, and a controller configured to control at least the torque distribution mechanism. When the steering wheel is steered in reverse and a yaw rate difference related value related to a difference between a target yaw rate to be generated on the vehicle according to the steering of the steering wheel and an actual yaw rate actually generated on the vehicle is greater than or equal to a first predetermined value, the controller controls the torque distribution mechanism to reduce the torque distributed to the rear wheels.

### TECHNICAL FIELD

The present disclosure relates to a vehicle system which controls a posture of a vehicle, which is configured to distribute torque of a drive source to front wheels and rear wheels.

### BACKGROUND OF THE DISCLOSURE

Conventionally, it is known that when behavior of a vehicle becomes unstable due to a slip, etc., the behavior of the vehicle is controlled in a safer direction (antiskid brake system, etc.). In detail, during cornering, etc. of the vehicle, a behavior such as understeering or oversteering occurring on the vehicle is detected, and a suitable deceleration is applied to wheels so that the behavior is controlled.

Moreover, unlike the control for improving safety during the traveling state where the behavior of the vehicle becomes unstable as described above, for example, JP5143103B2 discloses a motion control device for a vehicle in which an acceleration and a deceleration collaborated with operation of a steering wheel which is operated from an everyday operating range are performed automatically and a skid is reduced within a near-limit operating range. Particularly, the motion control device disclosed in JP5143103B2 is provided with a first mode in which the acceleration and deceleration in the front-and-rear direction of the vehicle is controlled, and a second mode in which a yaw moment of the vehicle is controlled.

With the technology disclosed in JP5143103B2, the yaw moment is applied to the vehicle in the second mode. Typically, the control for applying the yaw moment to the vehicle is executed when a steering wheel is returned toward a neutral position (hereinafter, may be referred to as “steering in reverse”). That is, when steering in reverse is carried out, a braking force is applied to a turning outer wheel (an outer wheel with respect to the turning center of the vehicle) from a brake apparatus so that a yaw moment in the opposite direction of the yaw moment occurring on the vehicle is applied, in order to suppress yawing of the vehicle, i.e., to stimulate a return to the straight-forward traveling state.

Meanwhile, in a vehicle of which the rear wheels are primary driving wheels, the rear wheels may slip when an accelerator pedal is depressed during the steering in reverse, because torque is applied to the rear wheels. As a result, the vehicle tends to be oversteered. When such an oversteering tendency occurs in the vehicle, it is difficult to fully suppress the oversteering tendency by the control in which the yaw moment is applied to the vehicle by applying the braking force to the turning outer wheel as disclosed in JP5143103B2.

### SUMMARY OF THE DISCLOSURE

The present disclosure is made in view of solving the problem of the conventional technology described above, and one purpose thereof is to provide a vehicle system which is capable of appropriately suppressing an oversteering tendency of a vehicle by controlling a torque distribution ratio of front wheels and rear wheels during a steering in reverse.

According to one aspect of the present disclosure, a vehicle system is provided, which includes a drive source configured to generate torque for driving a vehicle, wheels including rear wheels that are primary driving wheels and front wheels that are auxiliary driving wheels, a torque distribution mechanism configured to distribute the torque of the drive source to the front wheels and the rear wheels, a steering wheel configured to be operated by a driver, and a controller configured to control at least the torque distribution mechanism. When the steering wheel is steered in reverse and a yaw rate difference related value related to a difference between a target yaw rate to be generated on the vehicle according to the steering of the steering wheel and an actual yaw rate actually generated on the vehicle is greater than or equal to a first predetermined value, the controller controls the torque distribution mechanism to reduce the torque distributed to the rear wheels among the torque of the drive source.

According to this configuration, when the steering wheel is steered in reverse and the yaw rate difference related value related to the difference between the target yaw rate and the actual yaw rate is greater than or equal to the first predetermined value, the controller controls the torque distribution mechanism to reduce the torque distributed to the rear wheels which are the primary driving wheels. Therefore, during the steering in reverse of the steering wheel, for example, even when an accelerator pedal is depressed, the slip of the rear wheels can be prevented by reducing the torque of the rear wheels exactly. As a result, the vehicle can be prevented beforehand from a tendency to oversteer during the steering in reverse of the steering wheel, and thus, stabilization of a vehicle posture can be achieved.

The vehicle system may further include a brake apparatus configured to apply a braking force to the wheels. When the yaw rate difference related value is greater than or equal to a second predetermined value that is larger than the first predetermined value, the controller may control the brake apparatus to apply a yaw moment in the opposite direction of the actual yaw rate to the vehicle.

According to this configuration, when the yaw rate difference related value is greater than or equal to the second predetermined value (which is greater than the first predetermined value), the controller executes the control for applying the yaw moment in the opposite direction of the actual yaw rate to the vehicle, in addition to the control for reducing the torque distributed to the rear wheels by the torque distribution mechanism as described above. Therefore, the vehicle can be effectively prevented from a tendency to oversteer, and restorability from turning can be effectively improved.

When the yaw rate difference related value is greater than or equal to a third predetermined value that is larger than the second predetermined value, the controller may control the brake apparatus to apply to the vehicle the yaw moment that is larger than that when the yaw rate difference related value is greater than or equal to the second predetermined value and less than the third predetermined value.

According to this configuration, when the yaw rate difference related value is greater than or equal to the third predetermined value (which is greater than the second predetermined value), the controller executes the control for applying the comparatively large yaw moment to the vehicle. That is, even if the controller executes the control for reducing the torque distributed to the rear wheels when the yaw rate difference related value becomes greater than or equal to the first predetermined value, and the control for applying the yaw moment to the vehicle when the yaw rate difference related value becomes greater than or equal to the second predetermined value, the controller executes the control for applying the comparatively large yaw moment to the vehicle when the vehicle skid has occurred. Therefore, the vehicle skid is certainly prevented.

The controller may control the torque distribution mechanism to, when the steering wheel is steered forward, increase the torque distributed to the rear wheels, when the steering wheel is then steered in reverse, reduce the torque distributed to the rear wheels, and when the steering wheel is steered in reverse and the yaw rate difference related value is greater than or equal to the first predetermined value, increase a reducing amount of the torque distributed to the rear wheels more than that when the yaw rate difference related value is less than the first predetermined value.

According to this configuration, when the steering wheel is steered forward, the controller increases the torque distributed to the rear wheels to generate a pitching in a forward-inclining direction on the vehicle. Therefore, while a response feeling can be imparted to the driver during a turn-in, a turning response of the vehicle to the steering forward of the steering wheel can be improved. Then, during the steering in reverse of the steering wheel, the controller reduces the torque distributed to the rear wheels to generate a pitching in a rearward-inclining direction on the vehicle. Therefore, while a stable feel can be imparted to the driver during a turn-out, the restorability from the turning can be improved. Moreover, when reducing the torque distributed to the rear wheels during the steering in reverse of the steering wheel as described above, and the yaw rate difference related value is greater than or equal to the first predetermined value, the controller makes the reducing amount of the torque distributed to the rear wheels more than that when the yaw rate difference related value is less than the first predetermined value. Therefore, the vehicle can effectively be prevented from a tendency to oversteer.

The yaw rate difference related value may include a rate of change in the difference between the target yaw rate and the actual yaw rate, and/or the difference between the target yaw rate and the actual yaw rate.

### BRIEF DESCRIPTION OF DRAWINGS

FIG. 1 is a block diagram illustrating the overall configuration of a vehicle to which a vehicle system according to one embodiment of the present disclosure is applied.

FIG. 2 is a block diagram illustrating an electrical configuration of the vehicle system according to this embodiment of the present disclosure.

FIG. 3 is a graph of a fundamental setting technique of a torque distribution ratio according to this embodiment of the present disclosure.

FIGS. 4A and 4B are views of pitching caused on the vehicle when a distributed torque of a rear wheel is increased and decreased, respectively.

FIG. 5 is a flowchart illustrating the entire control according to this embodiment of the present disclosure.

FIG. 6 is a flowchart illustrating a torque reduction setting according to this embodiment of the present disclosure.

FIG. 7 is a map illustrating a relationship between an additional deceleration and a steering rate according to this embodiment of the present disclosure.

FIG. 8 is a flowchart illustrating a target yaw moment setting according to this embodiment of the present disclosure.

FIG. 9 is a flowchart illustrating a torque distribution setting according to this embodiment of the present disclosure.

FIGS. 10A to 10F are maps for setting a target yaw rate and a target lateral acceleration according to this embodiment of the present disclosure.

FIGS. 11A and 11B are maps for setting a first gain and a second gain according to this embodiment of the present disclosure, respectively.

FIG. 12 is a flowchart illustrating a skid prevention control according to this embodiment of the present disclosure.

FIG. 13 illustrates one example of a time chart when executing a vehicle attitude control according to this embodiment of the present disclosure.

FIG. 14 illustrates another example of the time chart when executing the vehicle attitude control according to this embodiment of the present disclosure.

### DETAILED DESCRIPTION OF THE DISCLOSURE

Hereinafter, a vehicle system according to one embodiment of the present disclosure is described with reference to the accompanying drawings.

### <System Configuration>

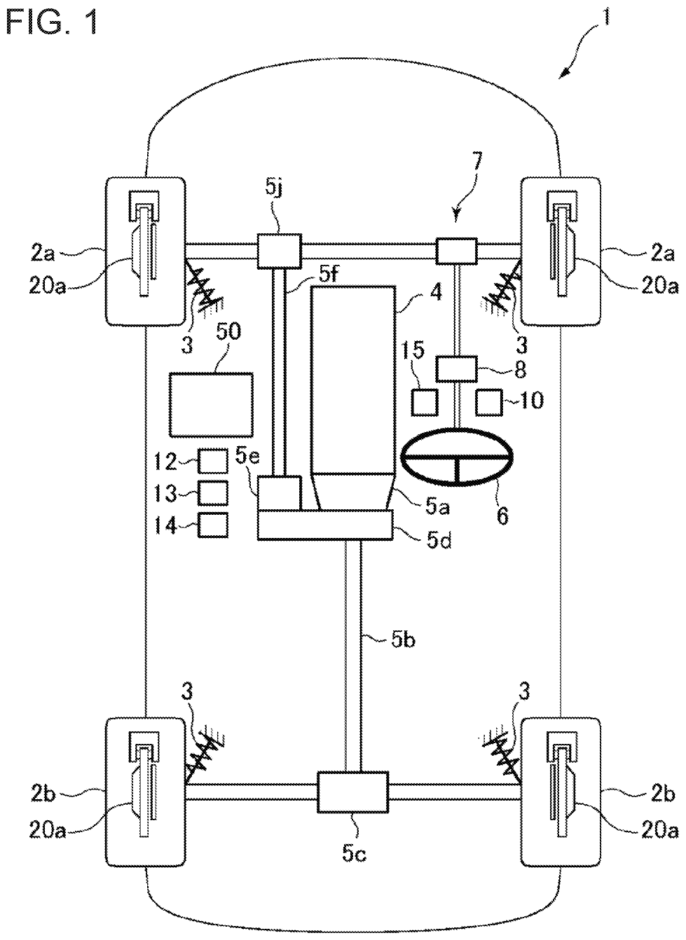

First, a configuration of the vehicle system according to this embodiment of the present disclosure is described. FIG. 1 is a block diagram illustrating the overall configuration of a vehicle to which the vehicle system according to this embodiment of the present disclosure is applied.

As illustrated in FIG. 1, in a vehicle 1, left and right front wheels 2a which are steering wheels and auxiliary driving wheels are provided to a front part of a vehicle body, and left and right rear wheels 2b which are primary driving wheels are provided to a rear part of the vehicle body. The front wheels 2a and the rear wheels 2b of the vehicle 1 are supported by the vehicle body through suspensions 3. Moreover, an engine 4 which is a drive source (prime mover) which mainly drives the rear wheels 2b is mounted on the front part of the vehicle body of the vehicle 1. In this embodiment, although the engine 4 is a gasoline engine, an internal combustion engine, such as a diesel engine, or a motor which is driven by electric power may be used as the drive source.

Moreover, the vehicle 1 is a four-wheel drive (4WD) vehicle of a front-engine rear-drive system (FR system). In detail, the vehicle 1 is provided with a transmission 5a which is coupled to the engine 4 and transmits an engine output to the wheels. A propeller shaft 5b extends from the transmission 5a and is coupled to the rear wheels 2b through a differential gear 5c, etc. On the other hand, the front wheels 2a are connected to the propeller shaft 5b through a transfer 5d and an electromagnetic coupling 5e. In more detail, the front wheels 2a and the propeller shaft 5b are coupled to each other through a power transmission shaft 5f and a differential gear 5j, in addition to the transfer 5d and the electromagnetic coupling 5e.

The transfer 5d is a device for branching torque of the propeller shaft 5b (vehicle driving force) to the power transmission shaft 5f The electromagnetic coupling 5e is a coupling which couples the power transmission shaft 5f to the propeller shaft 5b, includes a magnet coil, a cam mechanism, a clutch, etc. which are not illustrated, and is an example of a “torque distribution mechanism” in the present disclosure. The electromagnetic coupling 5e is configured to vary a degree of coupling or engagement (in detail, an engaging torque) of the electromagnetic coupling 5e according to electric current supplied to the internal magnet coil. Thus, by changing the degree of engagement, torque transmitted to the power transmission shaft 5f from the propeller shaft 5b (i.e., torque transmitted to the front wheels 2a) can be changed, while the power transmission shaft 5f is coupled to the propeller shaft 5b. That is, a torque distribution ratio which is a ratio of the torque distributed to the front wheels 2a and the torque distributed to the rear wheels 2b among the output torque of the engine 4 is changed. Fundamentally, the torque distributed to the rear wheels 2b as the primary driving wheels becomes smaller and the torque distributed to the front wheels 2a as the auxiliary driving wheels becomes larger as the degree of engagement of the electromagnetic coupling 5e is increased. On the other hand, the torque distributed to the rear wheels 2b as the primary driving wheels becomes larger and the torque distributed to the front wheels 2a as the auxiliary driving wheels becomes smaller as the degree of engagement of the electromagnetic coupling 5e decreases.

Moreover, a steering device 7 including a steering wheel 6, etc. is mounted on the vehicle 1, and the front wheels 2a of the vehicle 1 are steered based on a rotating operation of the steering wheel 6. In addition, a brake apparatus 20a for giving a braking force to the vehicle 1 is provided to each wheel (the front wheels 2a and the rear wheels 2b).

Further, the vehicle 1 includes a steering angle sensor 8 which detects a steering angle of the steering device 7, an accelerator opening sensor 10 which detects a depressing amount of an accelerator pedal (accelerator opening), a vehicle speed sensor 12 which detects a speed of the vehicle, a yaw rate sensor 13 which detects a yaw rate, an acceleration sensor 14 which detects an acceleration of the vehicle, and a brake depressing amount sensor 15 which detects a depressing amount of a brake pedal. Although the steering angle sensor 8 typically detects a rotation angle of the steering wheel 6, it may detect a steered angle (tire angle) of the front wheels 2a, additionally or alternatively to the rotation angle. These sensors output respective detection signals to a controller 50.

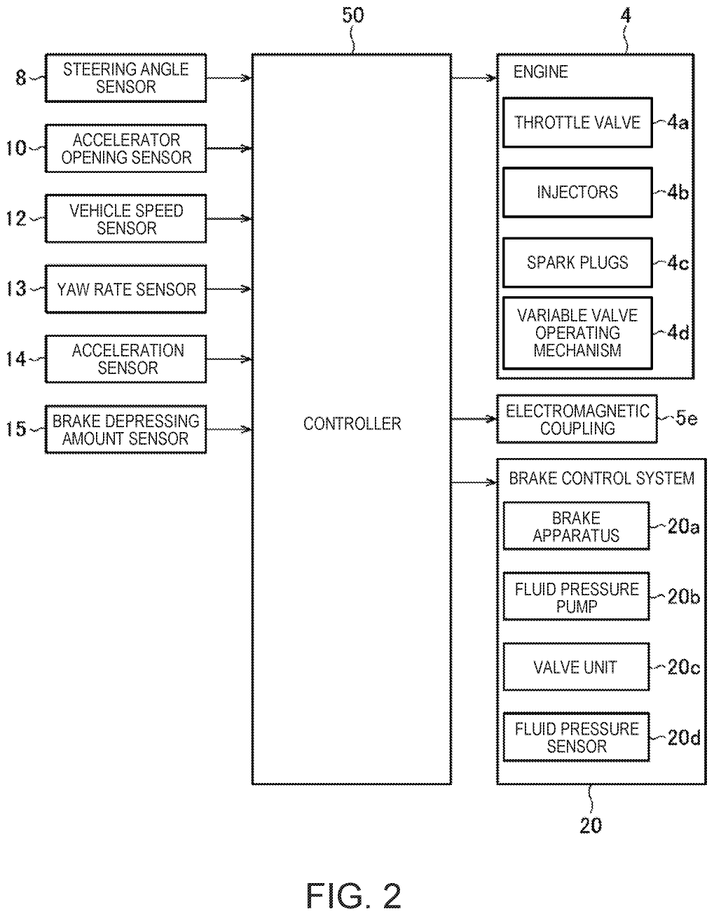

Next, referring to FIG. 2, a block diagram illustrating an electrical configuration of the vehicle system according to this embodiment of the present disclosure is described.

The controller 50 according to this embodiment outputs control signals based on the detection signals outputted from the various sensors which detect an operating state, etc. of the engine 4 other than the detection signals of the sensors 8, 10, 12, 13 14, and 15 described above to perform controls of a throttle valve 4a, an injector (fuel injection valve) 4b, a spark plug 4c, and a variable valve operating mechanism 4d of the engine 4.

Moreover, the controller 50 controls a brake control system 20 including the brake apparatuses 20a described above. The brake control system 20 is a system which supplies brake fluid pressure to a wheel cylinder and a brake caliper of each brake apparatus 20a. The brake control system 20 is provided with a fluid pressure pump 20b which generates brake fluid pressure required for generating the braking force at the brake apparatus 20a provided to each wheel. The fluid pressure pump 20b is driven by electric power supplied, for example, from a battery, and thus, it can generate the brake fluid pressure required for generating the braking force at each brake apparatus 20a even when the brake pedal is not depressed. The brake control system 20 is also provided with a valve unit 20c (in detail, a solenoid valve) which is provided to a fluid pressure supply line to the brake apparatus 20a of each wheel and controls the fluid pressure supplied to the brake apparatus 20a of each wheel from the fluid pressure pump 20b. For example, a valve opening of the valve unit 20c is changed by adjusting electric power supply from the battery to the valve unit 20c. The brake control system 20 is also provided with a fluid pressure sensor 20d which detects the fluid pressure supplied to the brake apparatus 20a of each wheel from the fluid pressure pump 20b. The fluid pressure sensor 20d is disposed, for example, at a connection of each valve unit 20c to the fluid pressure supply line downstream thereof, detects the fluid pressure downstream of each valve unit 20c, and outputs a detection value to the controller 50. Such a brake control system 20 calculates the fluid pressure which is independently supplied to the wheel cylinder and the brake caliper of each wheel based on a braking force instruction value inputted from the controller 50 and the detection value of the fluid pressure sensor 20d, and controls the rotation speed of the fluid pressure pump 20b and the valve opening of the valve unit 20c according to the fluid pressure.

The controller 50 includes a PCM (Power-train Control Module) which is not illustrated. The controller 50 is comprised of a computer provided with one or more processors, various kinds of programs which are interpreted and executed by the processors (including a basic control program, such as an operating system (OS), and an application program which is activated on the OS and achieves a specific function), and internal memory, such as a ROM and a RAM, which stores the programs and various kinds of data.

The controller 50 also performs a control of the electromagnetic coupling 5e. In detail, the controller 50 adjusts an applied electric current which is supplied to the electromagnetic coupling 5e to control the torque distribution ratio of the front wheels 2a and the rear wheels 2b.

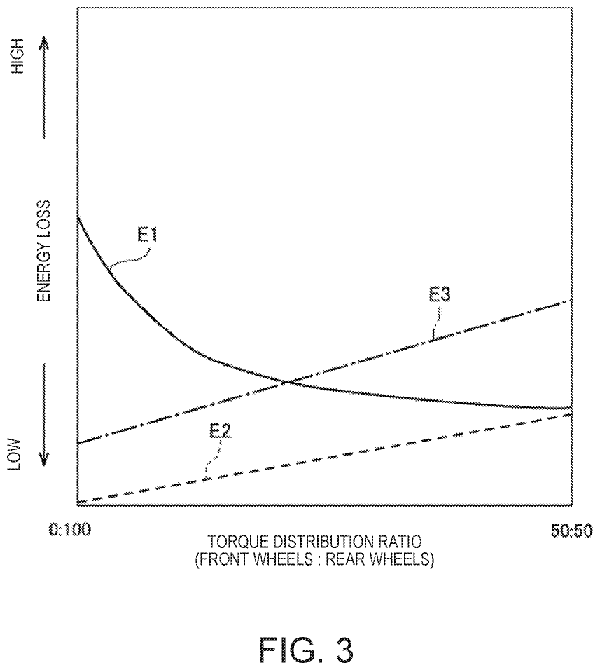

Here, a fundamental technique for setting the torque distribution ratio in this embodiment of the present disclosure is described with reference to FIG. 3. In FIG. 3, the horizontal axis indicates the torque distribution ratio (in detail, [torque distributed to the front wheels 2a]: [torque distributed to the rear wheels 2b]), and the vertical axis indicates energy loss. In detail, a graph E1 indicates the energy loss due to a slip of the rear wheels 2b (primary driving wheels) with respect to the torque distribution ratio, a graph E2 indicates the energy loss due to a slip of the front wheels 2a (auxiliary driving wheels) with respect to the torque distribution ratio, and a graph E3 indicates the energy loss corresponding to mechanical loss of the torque transfer mechanisms (electromagnetic coupling 5e, the power transmission shaft 5f, the differential gear 5j, etc.) during the power transfer to the front wheels 2a (auxiliary driving wheels) with respect to the torque distribution ratio.

As illustrated in the graph E1, the energy loss due to the slip of the rear wheels 2b decreases as the torque distribution ratio goes to the right, i.e., the amount of torque distribution to the front wheels 2a increases. On the other hand, as illustrated in the graph E2, the energy loss due to the slip of the front wheels 2a increases as the amount of torque distribution to the front wheels 2a increases, and as illustrated in the graph E3, the energy loss corresponding to the mechanical loss during the power transfer to the front wheels 2a increases as the amount of torque distribution to the front wheels 2a increases. In this embodiment, fundamentally, the controller 50 calculates the sum total of these three energy losses E1, E2, and E3, and determines a torque distribution ratio at which the sum total of the energy losses becomes the minimum. Then, the controller 50 controls the applied current supplied to the electromagnetic coupling 5e so that the determined torque distribution ratio is achieved.

Note that the vehicle system of the present disclosure is mainly comprised of the engine 4 as the drive source, the front wheels 2a and the rear wheels 2b, the electromagnetic coupling 5e as the torque distribution mechanism, the steering wheel 6, and the controller 50 as the controller.

### <Details of Control>

Next, details of the control executed by the controller 50 in this embodiment are described.

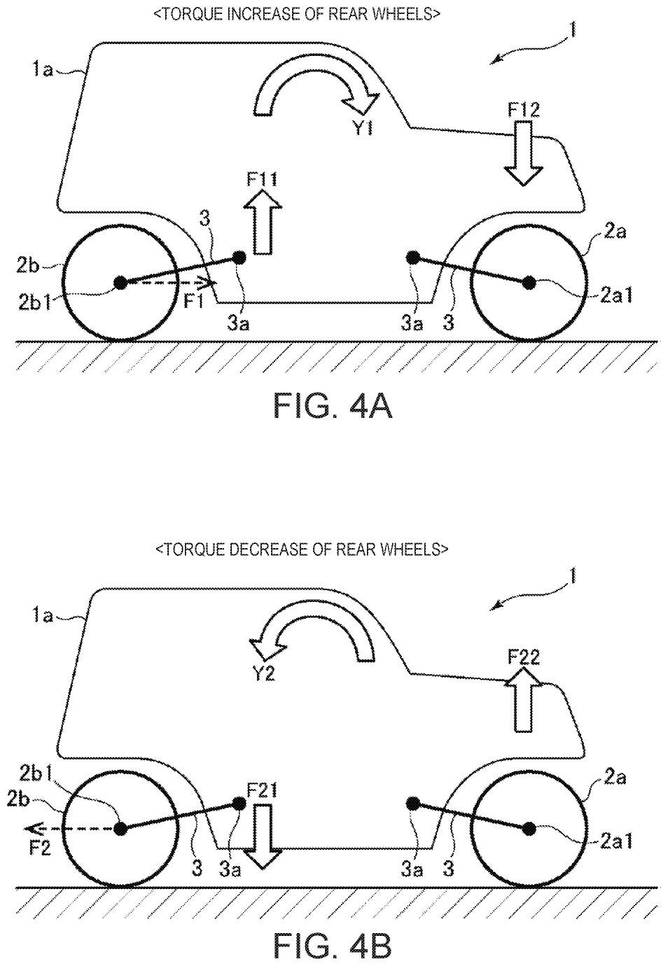

First, referring to FIGS. 4A and 4B, outline of the contents of the control according to this embodiment is described. FIG. 4A is a view of pitching caused on the vehicle 1 when the electromagnetic coupling 5e is controlled to increase the torque distributed to the rear wheel(s) 2b, and FIG. 4B is a view of the pitching caused on the vehicle 1 when the electromagnetic coupling 5e is controlled to reduce the torque distributed to the rear wheel(s) 2b. As illustrated in FIGS. 4A and 4B, a vehicle body 1a of the vehicle 1 is suspended by the suspensions 3 between the front wheels 2a and the rear wheels 2b, respectively, and each suspension 3 has an attaching part 3a to the vehicle body 1a above a center axis 2b1 of the rear wheels 2b (similar for a center axis 2a1 of the front wheels 2a).

In this embodiment, as illustrated in FIG. 4A, the controller 50 performs a control to decrease the degree of engagement of the electromagnetic coupling 5e based on the steering forward of the steering wheel 6 (a steering forward in one direction from a neutral position) detected by the steering angle sensor 8. That is, the controller 50 controls the electromagnetic coupling 5e to increase the torque distributed to the rear wheels 2b during a turn-in of the vehicle 1.

Thus, when the torque distributed to the rear wheels 2b increases, a force F1 for propelling the rear wheels 2b forward is transmitted to the vehicle body 1a through the suspensions 3 from the rear wheels 2b. In this case, since the suspensions 3 extend obliquely upward to the attaching parts 3a of the vehicle body 1a from the center axis 2b1 of the rear wheels 2b, an upward force component F11 of the force F1 for propelling the rear wheels 2b forward occurs on the vehicle body 1a, i.e., the force F11 for lifting a rear part of the vehicle body 1a upward acts on the vehicle body 1a momentarily. As a result, a moment Y1 as illustrated in FIG. 4A occurs to generate pitching of the vehicle body 1a in the forward-inclining direction. Thus, as the pitching of the vehicle body 1a is generated in the forward-inclining direction during the turn-in, a response feel can be imparted to a vehicle driver.

Moreover, by the moment Y1 in the generating direction of the pitching in the forward-inclining direction, a force F12 for depressing the front part of the vehicle body 1a downward acts on the vehicle body 1a, and therefore, the front part of the vehicle body 1a sinks to increase the front wheel load. Therefore, the turning response of the vehicle 1 to the steering forward of the steering wheel 6 is improved. Note that when the torque of the rear wheels 2b is increased as described above, an inertia force for inclining the vehicle body 1a rearward may also be generated, in addition to the momentary force for inclining the vehicle body 1a forward, but the momentary force for inclining the vehicle body 1a forward caused by the increase in torque of the rear wheels 2b contributes dominantly to the vehicle response to the steering forward of the steering wheel 6.

Here, in this embodiment, the controller 50 executes the control for generating the pitching of the vehicle body 1a in the forward-inclining direction by increasing the torque distributed to the rear wheels 2b as described above (hereinafter, suitably referred to as a “first vehicle attitude control”) only when the torque of the engine 4 is below a given value (typically, in a case of “accelerator off”) and the steering forward of the steering wheel 6 is performed. On the other hand, even when the steering forward of the steering wheel 6 is performed, when the torque of the engine 4 is above the given value (typically, in a case of “accelerator on”), the controller 50 executes a control in which a torque reduction of the engine 4 is set based on the steering forward of the steering wheel 6 without carrying out the first vehicle attitude control, and the torque of the engine 4 is reduced by the torque reduction (hereinafter, suitably referred to as a “second vehicle attitude control”). According to this second vehicle attitude control, since the deceleration occurs on the vehicle 1 by the reduction in torque, the front wheel load increases and the turning response of the vehicle 1 to the steering forward of the steering wheel 6 is improved.

As described above, in this embodiment, if the torque of the engine 4 is below the given value while the steering forward of the steering wheel 6 is performed, since the torque of the engine 4 cannot be appropriately reduced based on the torque reduction, the controller 50 executes the control for increasing the torque distributed to the rear wheels 2b by using the electromagnetic coupling 5e (first vehicle attitude control) to achieve a desired vehicle posture (a pitching state in the forward-inclining direction). On the other hand, if the torque of the engine 4 is above the given value while the steering forward of the steering wheel 6 is performed, since the torque of the engine 4 can be reduced appropriately, the controller 50 executes the control of the engine 4 for inhibiting the execution of the first vehicle attitude control and reducing the torque according to the steering forward of the steering wheel 6 (second vehicle attitude control). In this case, the controller 50 restricts a change in the torque distribution ratio caused by the electromagnetic coupling 5e in the first vehicle attitude control (e.g., a restriction is imposed to a rate of increase in the torque distributed to the rear wheels 2b). This is because the desired pitching cannot be generated appropriately if the first vehicle attitude control is executed as it is while the second vehicle attitude control is executed.

Note that the reason why the torque of the rear wheels 2b can be increased by the first vehicle attitude control when the torque of the engine 4 is below the given value, i.e., the reason why the torque of the rear wheels 2b can be increased although the engine 4 hardly generates the torque, is as follows. As for the electromagnetic coupling 5e, when the torque of the engine 4 is below the given value (typically, in the case of “accelerator off”), the rotation speed of the output shaft which transmits torque to the front wheel side becomes lower than the rotation speed of the input shaft to which torque is transmitted from the rear wheel side. In other words, because of the setting of the gear ratio of each component, the rotation speed of the input shaft of the power transmission shaft 5f located on the output side (front wheel side) of the electromagnetic coupling 5e is lower than the rotation speeds of the propeller shaft 5b and the transfer 5d located on the input side (rear wheel side) of the electromagnetic coupling 5e. In such a situation, when the degree of engagement (engaging torque) of the electromagnetic coupling 5e is lowered according to the steering forward of the steering wheel 6 as described above, since the rotation speed of the output shaft of the electromagnetic coupling 5e decreases, in detail, since the rotation speed of the input shaft of the electromagnetic coupling 5e is speed up by the slow-down amount of the rotation speed of the output shaft of the electromagnetic coupling 5e, the torque applied to the rear wheels 2b increases momentarily.

Further, in this embodiment, as illustrated in FIG. 4B, the controller 50 executes the control for increasing the degree of engagement of the electromagnetic coupling 5e based on the steering in reverse of the steering wheel 6 detected by the steering angle sensor 8. That is, the controller 50 controls the electromagnetic coupling 5e to reduce the torque distributed to the rear wheels 2b during the turn-out of the vehicle 1.

Thus, when the torque distributed to the rear wheels 2b is reduced, a force F2 which pulls the rear wheels 2b rearward is transmitted to the vehicle body 1a through the suspensions 3 from the rear wheels 2b. In this case, since the suspensions 3 extends obliquely downward to the center axis 2b1 of the rear wheels 2b from the attaching parts 3a of the vehicle body 1a, a downward force component F21 of the force F2 which pulls the rear wheels 2b rearward occurs on the vehicle body 1a, i.e., the force F21 for depressing the rear part of the vehicle body 1a downward acts on the vehicle body 1a momentarily. As a result, a moment Y2 as illustrated in FIG. 4B occurs to generate the pitching in the rearward-inclining direction in the vehicle body 1a. Thus, when the pitching in the rearward-inclining direction is generated in the vehicle body 1a during the turn-out, a stable feel can be imparted to the driver.

Moreover, by the moment Y2 in the generating direction of the pitching in the rearward-inclining direction, a force F22 for lifting the front part of the vehicle body 1a upward acts on the vehicle body 1a, and therefore, the front part of the vehicle body 1a rises to reduce the front wheel load. Therefore, the vehicle response to the steering in reverse of the steering wheel 6, i.e., the restorability from the turning (restorability of the vehicle 1 to the straight-forward traveling state), is improved. Below, such a control for reducing the torque distributed to the rear wheels 2b during the steering in reverse of the steering wheel 6 to generate the pitching in the rearward-inclining direction in the vehicle body 1a is suitably referred to as a “third vehicle attitude control.” Note that when the torque of the rear wheels 2b is decreased as described above, the inertia force for inclining the vehicle body 1a forward may be generated, in addition to the momentary force for inclining the vehicle body 1a rearward, but the momentary force for inclining the vehicle body 1a rearward by the torque reduction in the rear wheels 2b contributes dominantly to the vehicle response to the steering in reverse of the steering wheel 6.

Further, in this embodiment, during the steering in reverse of the steering wheel 6, if a rate of change in a difference between a target yaw rate to be generated in the vehicle 1 according to the steering of the steering wheel 6 and an actual yaw rate which is actually occurring on the vehicle 1 is above a given value, the controller 50 executes a control for increasing the degree of engagement of the electromagnetic coupling 5e more than that of the third vehicle attitude control. That is, during the steering in reverse of the steering wheel 6, if the rate of change in the difference between the target yaw rate and the actual yaw rate is below the given value, the controller 50 executes the third vehicle attitude control, and, on the other hand, if the rate of change in the difference between the target yaw rate and the actual yaw rate is above the given value, the controller 50 controls the electromagnetic coupling 5e to reduce the torque distributed to the rear wheels 2b more than that of the third vehicle attitude control (hereinafter, suitably referred to as a “fourth vehicle attitude control”). According to the fourth vehicle attitude control, during the steering in reverse of the steering wheel 6, for example, when the accelerator pedal is depressed, the slip of the rear wheels 2b can be reduced by reducing the torque of the rear wheels 2b accurately. As a result, the vehicle 1 is prevented beforehand from a tendency to oversteer during the steering in reverse of the steering wheel 6.

Further, in this embodiment, the controller 50 executes a control, during the steering in reverse of the steering wheel 6, for causing the brake apparatus 20a to apply a braking force to the turning outer wheel in order to add a yaw moment in the opposite direction to the yaw moment occurring on the vehicle 1 (hereinafter, suitably referred to as a “fifth vehicle attitude control”), in addition to the control for reducing the torque distributed to the rear wheels 2b described above (third or fourth vehicle attitude control). Therefore, the restorability from the turning is improved more effectively. In addition, in this embodiment, the controller 50 executes a skid prevention control when the vehicle 1 sideslips during turning. In detail, the controller 50 executes a control for applying a braking force by using the brake apparatus 20a so that a yaw moment that is considerably larger than that of the fifth vehicle attitude control is applied to the vehicle 1 when the skid of the vehicle 1 occurs (hereinafter, suitably referred to as a “sixth vehicle attitude control”). The sixth vehicle attitude control is a so-called “skid prevention control.” Therefore, the skid of the vehicle 1 is certainly prevented.

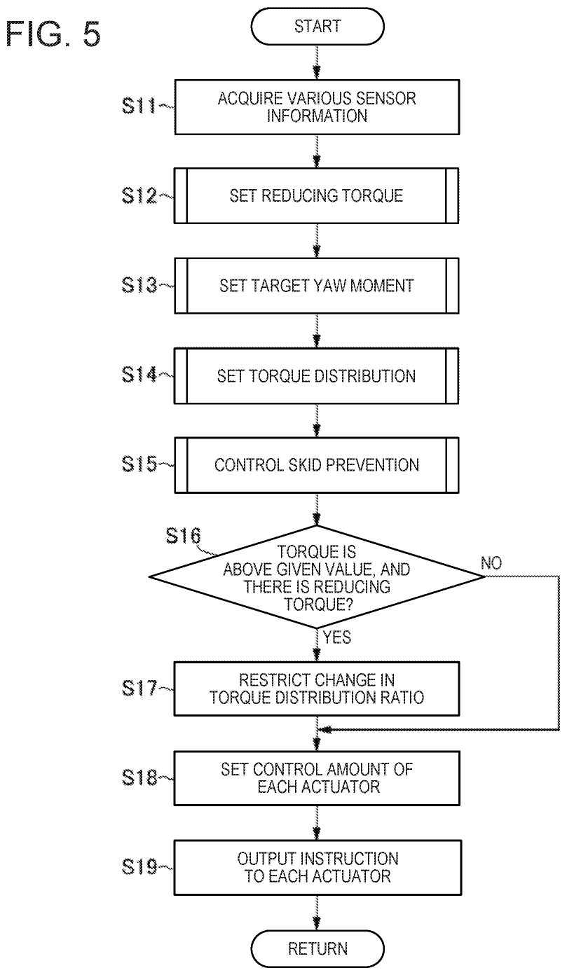

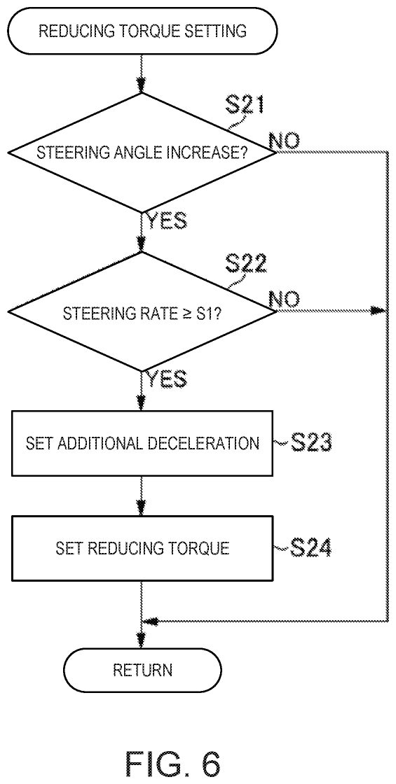

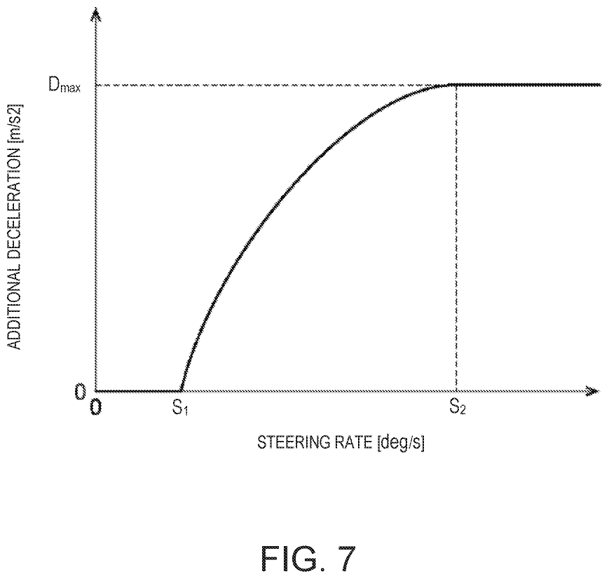

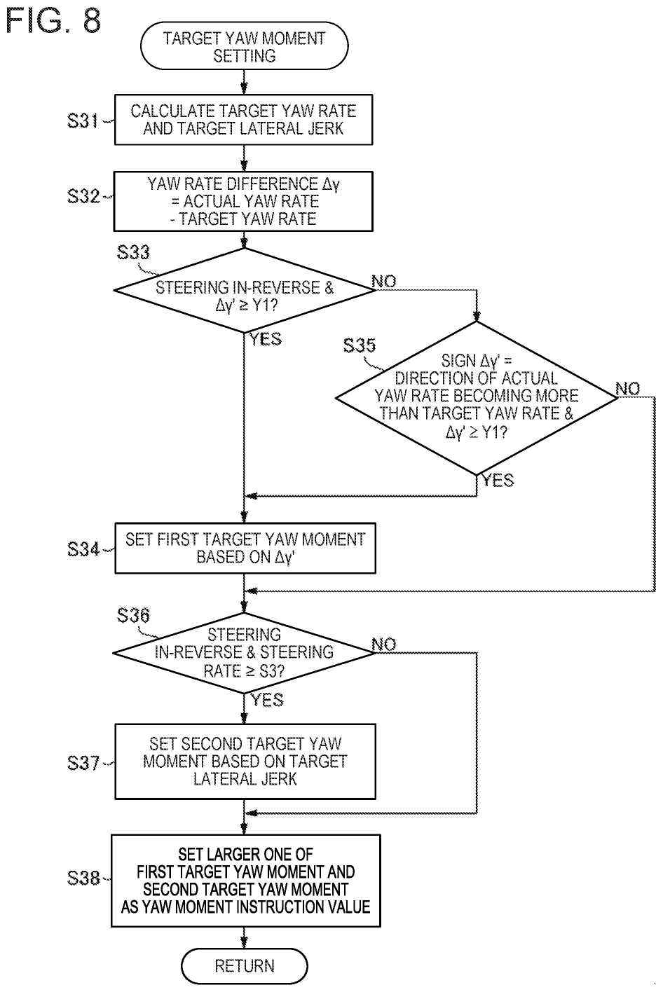

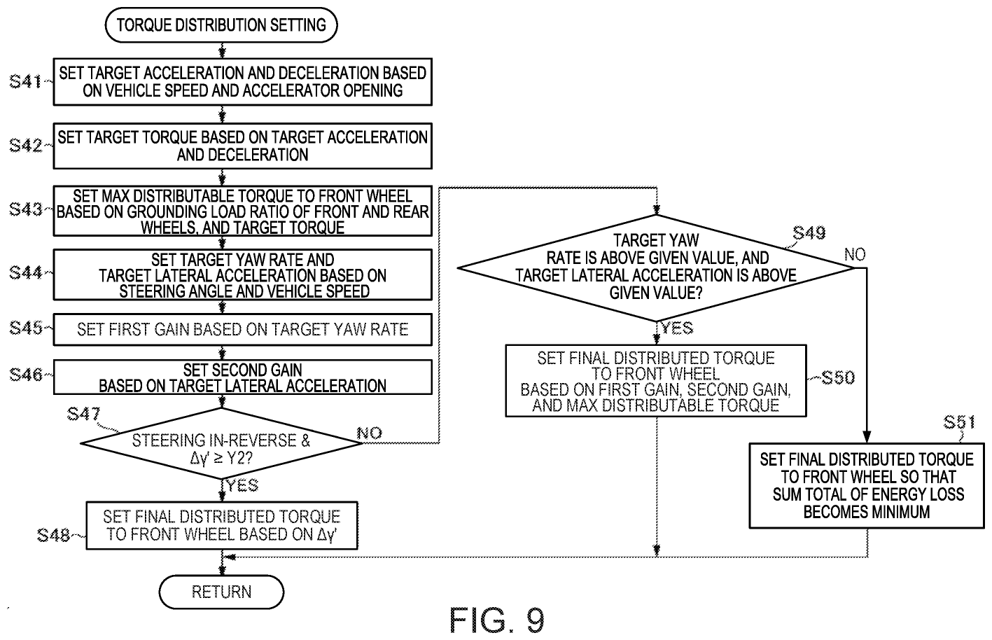

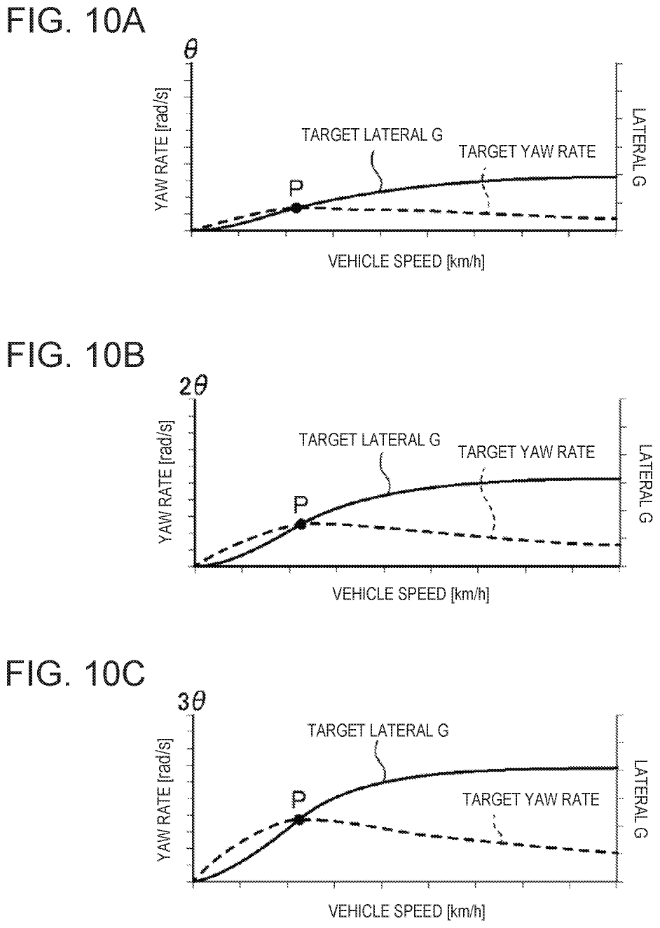

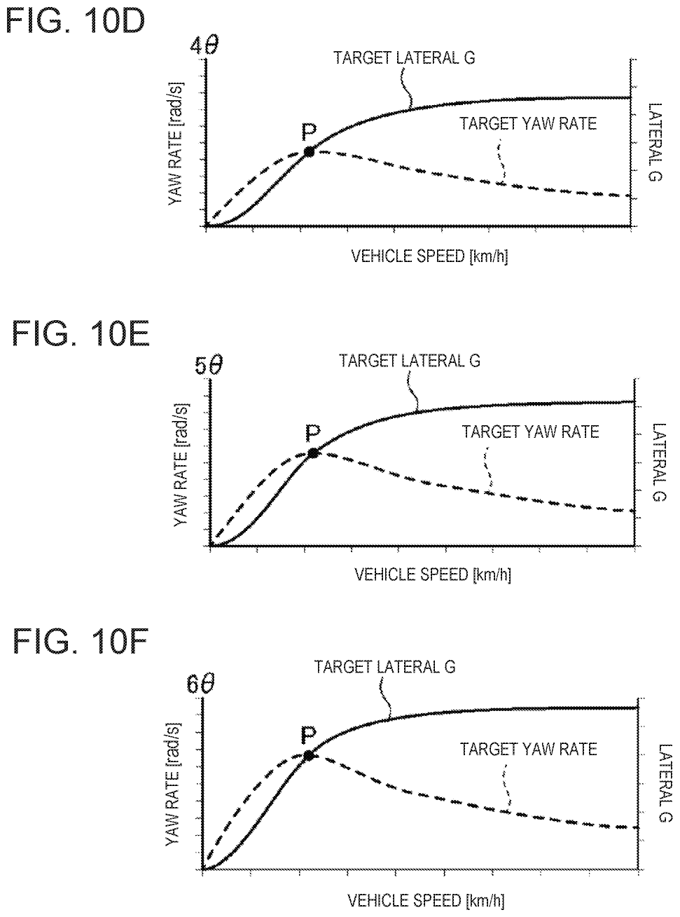

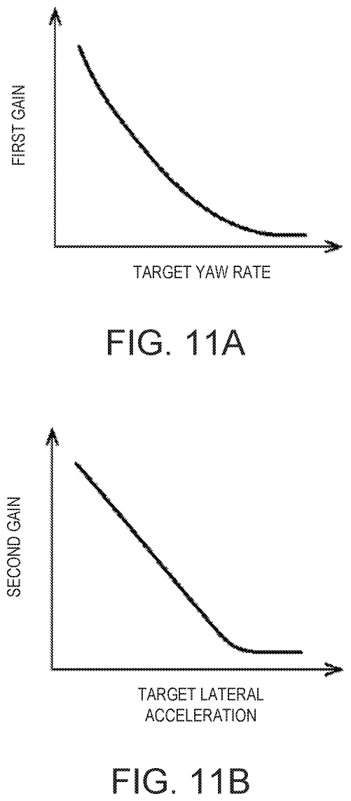

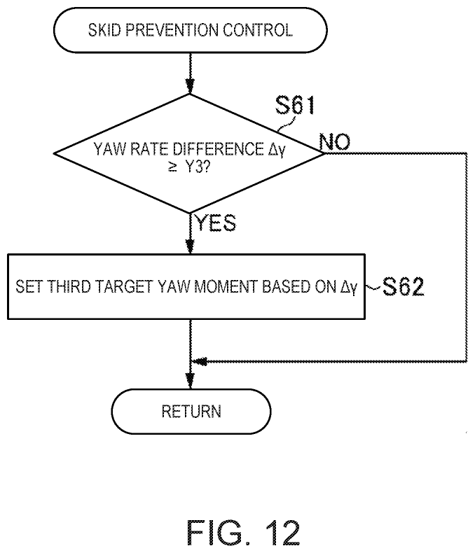

Next, referring to FIGS. 5 to 12, details of the control executed by the controller 50 in this embodiment are described concretely. FIG. 5 is a flowchart illustrating the overall control according to this embodiment of the present disclosure. FIG. 6 is a flowchart illustrating a torque reduction setting according to this embodiment of the present disclosure, which is executed in the entire control of FIG. 5, and FIG. 7 is a map which is used for the torque reduction setting of FIG. 6 and indicates a relationship between an additional deceleration and a steering rate according to this embodiment of the present disclosure. FIG. 8 is a flowchart illustrating a target yaw moment setting according to this embodiment of the present disclosure, which is executed in the overall control of FIG. 5. FIG. 9 is a flowchart illustrating a torque distribution setting according to this embodiment of the present disclosure, which is executed in the overall control of FIG. 5. FIGS. 10A to 10F are maps for setting the target yaw rate and a target lateral acceleration according to this embodiment of the present disclosure, which is used by the torque distribution setting of FIG. 9, and FIG. 11 is a map for setting a first gain and a second gain according to this embodiment of the present disclosure, which is used for the torque distribution setting of FIG. 9. FIG. 12 is a flowchart illustrating the skid prevention control according to this embodiment of the present disclosure, which is executed in the overall control of FIG. 5.

The control of FIG. 5 is started when the ignition of the vehicle 1 is turned ON and the power is supplied to the controller 50, and is repeatedly executed at a given cycle (e.g., 50 ms). When this control is started, at Step S11, the controller 50 acquires the various sensor information related to the operating state of the vehicle 1. In detail, the controller 50 acquires the detection signals outputted from the various sensors described above, including the steering angle detected by the steering angle sensor 8, the accelerator opening detected by the accelerator opening sensor 10, the vehicle speed detected by the vehicle speed sensor 12, the yaw rate detected by the yaw rate sensor 13, the acceleration detected by the acceleration sensor 14, the depressing amount of the brake pedal detected by the brake depressing amount sensor 15, an engine speed, a gear stage currently set in the transmission 5a of the vehicle 1, etc., as the information related to the operating state.

Next, at Step S12, the controller 50 executes the torque reduction setting for setting the torque to applying a deceleration to the vehicle 1 based on the steering operation as illustrated in FIG. 6 (torque reduction). In this Step S12, the controller 50 sets the torque reduction for reducing the torque of the engine 4 according to an increase in the steering angle of the steering device 7, i.e., the steering forward of the steering wheel 6. In this embodiment, the controller 50 controls the vehicle posture by reducing the torque temporarily and applying the deceleration to the vehicle 1 when the steering wheel 6 is steered forward (a second vehicle attitude control).

As illustrated in FIG. 6, when the torque reduction setting is started, the controller 50 determines at Step S21 whether the steering angle (absolute value) of the steering device 7 increases, i.e., whether the steering wheel 6 is steered forward. As a result, if it is determined that the steering angle increases (Step S21: Yes), the controller 50 shifts to Step S22, where it determines whether the steering rate is greater than or equal to a given threshold S₁. In this case, the controller 50 calculates the steering rate based on the steering angle acquired from the steering angle sensor 8 at Step S11 of FIG. 5, and then determines whether that value is the threshold S₁ or more.

As a result of Step S22, if it is determined that the steering rate is the threshold S₁ or more (Step S22: Yes), the controller 50 shifts to Step S23, where it sets the additional deceleration based on the steering rate. This additional deceleration is a deceleration to be applied to the vehicle 1 according to the steering operation, in order to control the vehicle posture as the driver intended.

In detail, the controller 50 sets the additional deceleration corresponding to the steering rate calculated at Step S22 based on the relationship between the additional deceleration and the steering rate which are illustrated in the map of FIG. 7. In FIG. 7, the horizontal axis indicates the steering rate and the vertical axis indicates the additional deceleration. As illustrated in FIG. 7, if the steering rate is less than the threshold S₁, the corresponding additional deceleration is zero (0). That is, if the steering rate is less than the threshold S₁, the controller 50 does not execute the control for applying the deceleration to the vehicle 1 based on the steering operation.

On the other hand, if the steering rate is the threshold S₁ or more, the controller 50 brings the additional deceleration corresponding to the steering rate closer to a given upper limit Dₘₐₓ as the steering rate increases. That is, the additional deceleration increases and a rate of increase in the amount becomes smaller as the steering rate increases. The upper limit Dₘₐₓ is set as a deceleration at which the driver does not sense that there is a control intervention, even if the deceleration is applied to the vehicle 1 according to the steering operation (e.g., 0.5 m/s²≈0.05 G). Further, if the steering rate is greater than or equal to a threshold S₂ larger than the threshold S₁, the additional deceleration is maintained at the upper limit Dₘₐₓ.

Next, at Step S24, the controller 50 sets the torque reduction based on the additional deceleration set at Step S23. In detail, the controller 50 determines the torque reduction required for achieving the additional deceleration by the reduction in the torque of the engine 4, based on the current vehicle speed, gear stage, road surface slope, etc. which are acquired at Step S₁l of FIG. 5. After Step S24, the controller 50 ends the torque reduction setting, and returns to the main routine of FIG. 5.

On the other hand, if it is determined that the steering angle is not increasing at Step S21 (Step S21: No), or if it is determined that the steering rate is less than the threshold S₁ at Step S22 (Step S22: No), the controller 50 ends the torque reduction setting without setting the reducing torque, and returns to the main routine of FIG. 5. In this case, the torque reduction is set as zero.

When returning to FIG. 5, the controller 50 shifts to Step S13 after the torque reduction setting (Step S12), where it executes the target yaw moment setting of FIG. 8 to set the target yaw moment to be applied to the vehicle 1 in the fifth vehicle attitude control.

As illustrated in FIG. 8, as the target yaw moment setting is started, the controller 50 calculates, at Step S31, the target yaw rate and a target lateral jerk based on the steering angle and the vehicle speed which are acquired at Step S11 of FIG. 5. In one example, the controller 50 calculates the target yaw rate by multiplying the steering angle by a coefficient according to the vehicle speed. In another example, the controller 50 determines the target yaw rate corresponding to the current steering angle and vehicle speed based on the maps of FIGS. 10A to 10F described later. Moreover, the controller 50 calculates the target lateral jerk based on the steering rate and the vehicle speed.

Next, at Step S32, the controller 50 calculates a difference (yaw rate difference) Δγ between the yaw rate (actual yaw rate) acquired at Step S11 of FIG. 5, which is detected by the yaw rate sensor 13, and the target yaw rate calculated at Step S31.

Next, at Step S33, the controller 50 determines whether the steering wheel 6 is steered in reverse (i.e., the steering angle is decreasing), and a change rate Δγ′ of the yaw rate difference (corresponding to a yaw rate difference related value) which can be acquired by differentiating the yaw rate difference Δγ by time is a given threshold Y₁ (corresponding to a second predetermined value) or more. As a result, if during the steering in reverse and the change rate Δγ′ of the yaw rate difference is the threshold Y₁ or more, the controller 50 transit to Step S34, where it sets the yaw moment in the opposite direction of the actual yaw rate of the vehicle 1 as a first target yaw moment based on the change rate Δγ′ of the yaw rate difference. In detail, the controller 50 calculates the magnitude of the first target yaw moment by multiplying the change rate Δγ′ of the yaw rate difference by a given coefficient.

On the other hand, at Step S33, if the steering wheel 6 is not steered in reverse (i.e., the steering angle is constant or increasing), or if the change rate Δγ′ of the yaw rate difference is less than the given threshold Y₁, the controller 50 shifts to Step S35, where it determines whether the change rate Δγ′ of the yaw rate difference has a tendency that the actual yaw rate becomes more than the target yaw rate (i.e., the behavior of the vehicle 1 becoming oversteer) and the change rate Δγ′ of the yaw rate difference becomes the threshold Y₁ or more. In detail, when the yaw rate difference is decreasing under the situation where the target yaw rate is more than the actual yaw rate, and when the yaw rate difference is increasing under the situation where the target yaw rate is less than the actual yaw rate, the controller 50 determines that the change rate Δγ′ of the yaw rate difference has the tendency that the actual yaw rate becomes more than the target yaw rate.

As a result, if the change rate Δγ′ of the yaw rate difference has the tendency that the actual yaw rate becomes more than the target yaw rate and the change rate Δγ′ of the yaw rate difference is the threshold Y₁ or more, the controller 50 shifts to Step S34, where it sets the yaw moment in the opposite direction of the actual yaw rate of the vehicle 1 as the first target yaw moment based on the change rate Δγ′ of the yaw rate difference.

After Step S34, or if the change rate Δγ′ of the yaw rate difference does not have the tendency that the actual yaw rate becomes more than the target yaw rate and the change rate Δγ′ of the yaw rate difference is less than the threshold Y₁ at Step S35, the controller 50 shifts to Step S36, where it determines whether the steering wheel 6 is steered in reverse (i.e., the steering angle is decreasing) and the steering rate is a given threshold S₃ or more.

As a result, if the steering wheel 6 is steered in reverse and the steering rate is the threshold S₃ or more, the controller 50 shifts to Step S37, where it sets the yaw moment in the opposite direction of the actual yaw rate of the vehicle 1 as a second target yaw moment based on the target lateral jerk calculated at Step S31. In detail, the controller 50 calculates the magnitude of the second target yaw moment by multiplying the target lateral jerk by a given coefficient.

After Step S37, or if the steering wheel 6 is not steered in reverse (i.e., the steering angle is constant or increasing) and the steering rate is less than the threshold S₃ at Step S36, the controller 50 shifts to Step S38, where it sets a larger one of the first target yaw moment set at Step S34 and the second target yaw moment set at Step S37 as a yaw moment instruction value. After Step S38, the controller 50 ends the target yaw moment setting, and returns to the main routine of FIG. 5.

Returning to FIG. 5, after the target yaw moment setting (Step S13), the controller 50 shifts to Step S14, where it executes the torque distribution setting of FIG. 9 to set the torque distribution ratio of the front wheels 2a and the rear wheels 2b to be achieved by controlling the electromagnetic coupling 5e. In particular, the controller 50 sets the torque to finally be distributed to the front wheels 2a by controlling the electromagnetic coupling 5e (hereinafter, referred to as a “final distributed torque”).

As illustrated in FIG. 9, as the torque distribution setting is started, the controller 50 sets, at Step S41, a target acceleration and deceleration based on the vehicle speed, the accelerator opening, the depressing amount of the brake pedal, etc. which are acquired at Step S11 of FIG. 5. In one example, the controller 50 selects an acceleration and deceleration characteristic map corresponding to the current vehicle speed and gear stage from the acceleration and deceleration characteristic maps on which various vehicle speeds and gear stages are defined (created beforehand and stored in the internal memory, etc.), and sets the target acceleration and deceleration corresponding to the current accelerator opening, depressing amount of the brake pedal, etc. while referring to the selected acceleration and deceleration characteristic map.

Next, at Step S42, the controller 50 determines the target torque to be generated by the engine 4, in order to achieve the target acceleration and deceleration set at Step S41. In this case, the controller 50 determines the target torque within a range of the outputtable torque of the engine 4, based on the current vehicle speed, gear stage, road surface slope, road surface μ, etc.

Next, at Step S43, the controller 50 sets the maximum torque that can be distributed to the front wheels 2a (maximum distributable torque) based on a grounding load ratio of the front wheels 2a and the rear wheels 2b, and the target torque set at Step S42. In detail, the controller 50 distributes the target torque to the front wheels 2a and the rear wheels 2b according to the grounding load ratio of the front wheels 2a and the rear wheels 2b, and sets the torque distributed to the front wheels 2a as the maximum distributable torque. Note that in one example, the controller 50 uses the grounding load ratio when the vehicle 1 is stopped as a reference, and calculates a current grounding load ratio of the vehicle 1 based on the acceleration and deceleration, etc. currently occurring on the vehicle 1.

Next, at Step S44, the controller 50 sets the target yaw rate and the target lateral acceleration (target lateral G) corresponding to the current steering angle and vehicle speed which are acquired at Step S11 of FIG. 5, while referring to the maps of FIGS. 10A to 10F. The maps of FIGS. 10A to 10F define the target yaw rate (vertical axis) and the target lateral acceleration (vertical axis) to be set according to the vehicle speed (horizontal axis) for different steering angles θ, 2θ, 3θ, 4θ, 5θ, and 6θ (θ<2θ<3θ<4θ<5θ<6θ). In each map, the target yaw rate is illustrated by a broken line, and the target lateral acceleration is illustrated by a solid line. As illustrated in FIGS. 10A to 10F, the target yaw rate has a tendency that the target yaw rate becomes larger as the vehicle speed increases within a range where the vehicle speed is below a given value, and the target yaw rate becomes smaller as the vehicle speed increases within a range where the vehicle speed is above the given value, and the target lateral acceleration has a tendency that the target lateral acceleration becomes larger and a rate of increase in the target lateral acceleration becomes smaller as the vehicle speed increases. Further, fundamentally, both the target yaw rate and the target lateral acceleration have a tendency that the target yaw rate and the target lateral acceleration become larger as the steering angle increases (θ→2θ43 3θ . . . →6θ). Note that in FIGS. 10A to 10F, a point P corresponds to a vehicle speed at which the magnitude relationship between the target yaw rate and the target lateral acceleration is switched. Moreover, in FIGS. 10A to 10F, although the maps corresponding to the six steering angles are illustrated, more than six maps corresponding to the steering angles are prepared in actual cases.

Next, at Step S45, the controller 50 sets the first gain corresponding to the target yaw rate set at Step S44 while referring to the map of FIG. 11A. This first gain is a value applied for increasing or reducing the torque distributed to the front wheels 2a by the electromagnetic coupling 5e in order to generate the desired pitching in the vehicle body 1a in the first or third vehicle attitude control. As illustrated in FIG. 11A, the map is defined so that the first gain (vertical axis) becomes smaller as the target yaw rate (horizontal axis) increases. In detail, this map is defined so that a relationship between the target yaw rate and the first gain is nonlinear and the first gain is set as a given lower limit or is brought closer to the lower limit as the target yaw rate increases. According to this map, the first gain becomes lower and the rate of change in the first gain becomes smaller as the target yaw rate increases.

Next, at Step S46, the controller 50 sets the second gain corresponding to the target lateral acceleration set at Step S44 while referring to the map of FIG. 11B. This second gain is also a value applied for increasing or reducing the torque distributed to the front wheels 2a by the electromagnetic coupling 5e in order to generate the desired pitching in the vehicle body 1a in the first or third vehicle attitude control. As illustrated in FIG. 11B, the map is defined so that the second gain (vertical axis) becomes smaller as the target lateral acceleration (horizontal axis) increases. In detail, this map is defined so that a relationship between the target lateral acceleration and the second gain is substantially linear within a range where the target lateral acceleration is below a given value, and the second gain is set as a given lower limit within a range where the target lateral acceleration is above the given value, regardless of the target lateral acceleration.

Next, at Step S47, the controller 50 determines whether the steering wheel 6 is steered in reverse and the change rate Δγ′ of the yaw rate difference obtained at Step S33 of FIG. 8 is a given threshold Y₂ or more (corresponding to the first predetermined value). Here, the controller 50 determines whether it is in a situation where the fourth vehicle attitude control according to this embodiment is to be executed, i.e., whether it is in a situation where it is predicted that the vehicle 1 tends to become an oversteer, for example, by depressing the accelerator pedal while the steering wheel 6 is steered in reverse. In order to achieve this determination appropriately, the threshold Y₂ for determining the change rate Δγ′ of the yaw rate difference at Step S47 is set as a value smaller than the threshold Y₁ (see Steps S33 and S35 of FIG. 8) for determining the change rate Δγ′ of the yaw rate difference, which is used for the target yaw moment setting according to the fifth vehicle attitude control described above. In other words, in order to prevent the oversteer tendency of the vehicle 1 beforehand, the threshold Y₂ applied in the fourth vehicle attitude control is set as the value smaller than the threshold Y₁ applied in the fifth vehicle attitude control so that the fourth vehicle attitude control is executed before the fifth vehicle attitude control.

As a result of Step S47, if during the steering in reverse and the change rate Δγ′ of a yaw rate difference is the threshold Y₂ or more (Step S47: Yes), the controller 50 shifts to Step S48 and sets the final distributed torque to the front wheels 2a based on the change rate Δγ′ of the yaw rate difference. In detail, the controller 50 sets the final distributed torque to the front wheels 2a larger and the torque distributed to the rear wheels 2b smaller as the change rate Δγ′ of the yaw rate difference increases. Fundamentally, the torque distributed to the rear wheels 2b is determined according to the change rate Δγ′ of the yaw rate difference so that the force applied to the rear wheels 2b is located in a friction circle (a grip limit of the tires is expressed by a circle in a coordinate system where a force (driving force) applied to the tires in the longitudinal direction is defined as the vertical axis and a force (lateral force) applied to the tires in the transverse direction is defined as the horizontal axis), i.e., so that the slip of the rear wheels 2b is prevented. Since the possibility that the force applied to the rear wheels 2b is located outside the friction circle becomes higher as the change rate Δγ′ of the yaw rate difference increases, i.e., since the possibility that the rear wheels 2b slips becomes higher, the torque distributed to the rear wheels 2b is made smaller.

In one example, the controller 50 can set the final distributed torque corresponding to the current value of Δγ′ based on the map where the final distributed torque to be set for the change rate Δγ′ of the yaw rate difference is defined and which is created in advance based on the viewpoint described above. In another example, the controller 50 may obtain the friction circle of the rear wheels 2b based on the road surface μ, the grounding load, etc., and may set the final distributed torque so that the force applied to the rear wheels 2b is located in the friction circle. In still another example, the controller 50 may determine the slip of the rear wheels 2b according to an increase slope, etc. of the wheel speed of the rear wheels 2b, and may set the final distributed torque so that the slip of the rear wheels 2b is prevented.

By applying the final distributed torque set in this way, the fourth vehicle attitude control for preventing the oversteer tendency of the vehicle 1 beforehand during the steering in reverse of the steering wheel 6 is achieved. Note that although the torque distributed to the rear wheels 2b during the steering in reverse of the steering wheel 6 is decreased also in a third vehicle attitude control described later, the controller 50 makes, in principle, the reducing amount (absolute value) of the torque of the rear wheels 2b in the fourth vehicle attitude control larger than the reducing amount (absolute value) of the torque of the rear wheels 2b in the third vehicle attitude control.

On the other hand, if not during the steering in reverse, or if the change rate Δγ′ of the yaw rate difference is less than the threshold Y₂ (Step S47: No), the controller 50 shifts to Step S49. In this case, the controller 50 determines whether the target yaw rate set at Step S44 is above the given value and the target lateral acceleration set at Step S44 is above the given value. Here, the controller 50 determines whether it is in a situation where the vehicle attitude control according to this embodiment is to be executed, i.e., whether the vehicle is in a turning state caused by the steering forward or the steering in reverse of the steering wheel 6.

As a result, if the target lateral acceleration is above the given value and the target yaw rate is above the given value (Step S49: Yes), the controller 50 shifts to Step S50, where it sets the final distributed torque to the front wheels 2a by multiplying the maximum distributable torque set at Step S43 by a smaller one of the first gain set at Step S45 and the second gain set at Step S46. That is, the controller 50 selects the gain among the first gain and the second gain which can change the maximum distributable torque more greatly, and changes the maximum distributable torque by using the selected gain to set the final distributed torque.

Here, since the steering angle becomes larger during the steering forward of the steering wheel 6, the set target yaw rate and target lateral acceleration become larger (see FIG. 10), and the first gain and the second gain become smaller (see FIG. 11). As a result, by applying the first gain or the second gain to the maximum distributable torque of the front wheels 2a, the final distributed torque of the front wheels 2a decreases and the torque distributed to the rear wheels 2b increases. Therefore, the control (first vehicle attitude control) for increasing the torque distributed to the rear wheels 2b in order to generate the pitching of the vehicle body 1a in the forward-inclining direction during the steering forward of the steering wheel 6 is achieved. On the other hand, during the steering in reverse of the steering wheel 6, since the steering angle becomes smaller, the set target yaw rate and target lateral acceleration become smaller (see FIG. 10) and the first gain and the second gain become larger (see FIG. 11). As a result, when the first gain or the second gain is applied to the maximum distributable torque of the front wheels 2a, the final distributed torque of the front wheels 2a increases and the torque distributed to the rear wheels 2b decreases. Therefore, during the steering in reverse of the steering wheel 6, the control (third vehicle attitude control) for reducing the torque distributed to the rear wheels 2b in order to generate the pitching of the vehicle body 1a in the rearward-inclining direction is achieved.

On the other hand, if the target yaw rate is above the given value and the target lateral acceleration is not above the given value (Step S49: No), the controller 50 shifts to Step S51. In this case, since the vehicle 1 is not in the turning state, it is not in the situation where the vehicle attitude control according to this embodiment is to be executed, and therefore, the controller 50 sets the final distributed torque at Step S51 so that the sum total of energy losses becomes the minimum. In detail, the controller 50 sets the torque distribution ratio of the front wheels 2a and the rear wheels 2b to be applied while referring to the map of FIG. 3. That is, the controller 50 calculates the sum total of the energy loss due to the slip of the rear wheels 2b, the energy loss due to the slip of the front wheels 2a, and the energy loss corresponding to the mechanical loss of the torque transfer mechanism caused by the power transfer to the front wheels 2a, and determines the torque distribution ratio at which the sum total of the energy losses becomes the minimum. Then, the controller 50 sets the final distributed torque corresponding to the torque distribution ratio.

After Step S48, S50, or S51, the controller 50 ends the torque distribution setting and returns to the main routine of FIG. 5.

Returning to FIG. 5, after the torque distribution setting (Step S14), the controller 50 shifts to Step S15, where it executes the skid prevention control of FIG. 12 to set the target yaw moment to be applied to the vehicle 1 in the sixth vehicle attitude control (skid prevention control).

As illustrated in FIG. 12, as the skid prevention control is started, the controller 50 determines at Step S61 whether the yaw rate difference Δγ obtained at Step S32 of FIG. 8 is a given threshold Y₃ or more (an example of a third predetermined value). Here, the controller 50 determines whether it is in a situation where the sixth vehicle attitude control according to this embodiment is to be executed, i.e., whether it is in a situation where the skid of the vehicle 1 is occurred. In order to achieve this determination appropriately, a value corresponding to a comparatively large yaw rate difference is applied to the threshold Y₃ for determining the yaw rate difference Δγ.

As a result of Step S61, if the yaw rate difference Δγ is the threshold Y₃ or more (Step S61: Yes), the controller 50 sets the yaw moment in the opposite direction of the actual yaw rate of the vehicle 1 as the third target yaw moment (Step S62), based on the yaw rate difference Δγ. In detail, the controller 50 sets the third target yaw moment larger as the yaw rate difference Δγ increases. For example, the controller 50 sets the third target yaw moment corresponding to the current value of Δγ based on the map which defines the third target yaw moment to be set for the yaw rate difference Δγ, and is created in advance in order to prevent the skid of the vehicle 1. Moreover, the controller 50 sets, in principle, a value larger than the first and second target yaw moments set in the target yaw moment setting of FIG. 8 described above, as the third target yaw moment. Then, when the third target yaw moment is set in this way, the controller 50 applies the third target yaw moment, instead of the first or second target yaw moment, even if the first or second target yaw moment is set by the target yaw moment setting of FIG. 8. Thus, the sixth vehicle attitude control for preventing the skid of the vehicle 1 is executed certainly. Then, the controller 50 ends the skid prevention control, and returns to the main routine of FIG. 5. On the other hand, if the yaw rate difference Δγ is less than the threshold Y₃ (Step S61: No), the controller 50 ends the skid prevention control, without setting the third target yaw moment, and returns to the main routine of FIG. 5.

Note that although it is determined in FIG. 12 whether the sixth vehicle attitude control is to be executed based on the yaw rate difference Δγ, in another example, it may be determined based on the change rate Δγ′ of the yaw rate difference instead of the yaw rate difference Δγ, similar to the fifth vehicle attitude control of FIG. 8 and the fourth vehicle attitude control of FIG. 9. Like these examples, when determining whether the sixth vehicle attitude control is to be executed based on the change rate Δγ′ of the yaw rate difference, a value larger than the threshold Y₁ (see Steps S33 and S35 of FIG. 8) applied in the fifth vehicle attitude control and the threshold Y₂ (see Step S47 of FIG. 9) applied in the fourth vehicle attitude control may be applied as the threshold for determining Δγ′. In still another example, it may be determined whether the sixth vehicle attitude control is to be executed based on the yaw rate difference Δγ, and it may be determined whether the fourth and fifth vehicle attitude controls are to be executed based on the yaw rate difference Δγ, instead of the change rate Δγ′ of the yaw rate difference. In this example, the threshold for determining the yaw rate difference Δγ in the fifth vehicle attitude control may be made larger than the threshold for determining the yaw rate difference Δγ in the fourth vehicle attitude control, and may be made smaller than the threshold (threshold Y₃ described above) for determining the yaw rate difference Δγ in the sixth vehicle attitude control.

Returning to FIG. 5, the controller 50 shifts to Step S16 after the skid prevention control described above (Step S15), where it determines whether the current torque (actual torque) of the engine 4 is above a given value and there is any torque reduction (i.e., whether the torque reduction is set in the torque reduction setting (Step S12) of FIG. 6). A value corresponding to the torque reduction (e.g., a value based on the assumed maximum value of the torque reduction) is used for the given value applied to the determination of the torque of the engine 4. Thus, by determining whether the torque of the engine 4 is above the given value, it can be determined whether the engine 4 is in the state where the torque reduction can be realized, i.e., whether it is in the state where the torque of the engine 4 can be appropriately reduced based on the torque reduction. Typically, during the accelerator off, the torque of the engine 4 becomes below the given value, and torque of the engine 4 cannot be appropriately reduced based on the torque reduction.

As a result of Step S16, if the torque of the engine 4 is above the given value and there is the torque reduction (Step S16: Yes), the controller 50 shifts to Step S17. In this case, since the torque reduction is set and the engine 4 is in the state where this torque reduction can be realized, the controller 50 executes the control (second vehicle attitude control) for reducing the torque of the engine 4 by the torque reduction according to the steering forward of the steering wheel 6, and restricts the change in the torque distribution ratio by the electromagnetic coupling 5e (Step S17). That is, the controller 50 restricts the change in the torque distribution ratio for realizing the final distributed torque set by the torque distribution setting (Step S14) of FIG. 9. In one example, the controller 50 controls the electromagnetic coupling 5e so that the rate of change in the torque distribution ratio becomes below a given speed limit and the torque distribution ratio typically changes at a fixed speed limit. In another example, the controller 50 inhibits the change in the torque distribution ratio by the electromagnetic coupling 5e so that the torque distribution ratio is maintained constant. After Step S17, the controller 50 shifts to Step S18.

On the other hand, if the torque of the engine 4 is below the given value or if there is no torque reduction (Step S16: No), the controller 50 shifts to Step S18, without executing the control at Step S17. Thus, the situation where the controller 50 shifts to Step S18 corresponds to, in addition to the case where the torque of the engine 4 is below the given value due to the accelerator off, etc., a case where the torque reduction is not set, such as a case where the vehicle 1 is substantially traveling straight, a case where the vehicle 1 is performing a normal turning after a steering forward of the steering wheel 6 and before a steering in reverse, and a case where the vehicle 1 is performing a resuming operation from a turning by the steering wheel 6 being steered in reverse. In such a case, the controller 50 executes the control based on the final distributed torque set by the torque distribution setting (Step S14) of FIG. 9 (also including the target yaw moment set by the target yaw moment setting (Step S13) of FIG. 8 or the skid prevention control (Step S15) of FIG. 12). Thus, if the torque reduction is set according to the steering forward of the steering wheel 6 when the torque of the engine 4 is below the given value, the first vehicle attitude control is executed instead of the second vehicle attitude control, and if the steering wheel 6 is steered in reverse, the third vehicle attitude control is executed (in this case, the fifth vehicle attitude control is also executed).

Next, the controller 50 sets at Step S18 a control amount of each actuator according to the processing result described above, and outputs at Step S19 a control instruction to each actuator based on the set control amount. In detail, the controller 50 outputs the control instruction to the engine 4, when executing the control based on the torque reduction set by the torque reduction setting of FIG. 6 (second vehicle attitude control). For example, the controller 50 retards an ignition timing of the spark plug 4c more than an ignition timing at which the original torque is generated without the torque reduction being applied. Moreover, alternatively or additionally to the retarding of the ignition timing, the controller 50 reduces an intake air amount by reducing a throttle opening of the throttle valve 4a, or controlling the variable valve operating mechanism 4d to retard a close timing of an intake valve set after a bottom dead center. In this case, the controller 50 reduces a fuel injection amount of the injector 4b corresponding to the reduction in the intake air amount so that a given air-fuel ratio is maintained. Note that if the engine 4 is a diesel engine, the controller 50 reduces the fuel injection amount from the injector 4b more than the fuel injection amount for generating the original torque to which the torque reduction is not applied.

Moreover, when executing the control based on the final distributed torque set by the torque distribution setting of FIG. 9, the controller 50 outputs the control instruction to the electromagnetic coupling 5e. In detail, in order to give the set final distributed torque to the front wheels 2a, the controller 50 controls the electromagnetic coupling 5e to set the degree of engagement (engaging torque) corresponding to the final distributed torque. In this case, the controller 50 supplies the applied current according to the final distributed torque of the front wheels 2a to the electromagnetic coupling 5e. Note that when Step S17 of FIG. 5 is performed, the controller 50 controls the electromagnetic coupling 5e to restrict the change in the torque distribution ratio.

Moreover, when executing the control based on the target yaw moment set by the target yaw moment setting of FIG. 8 or the skid prevention control of FIG. 12, the controller 50 outputs the control instruction to the brake control system 20 so that the target yaw moment is applied to the vehicle 1 by the brake apparatus 20a. The brake control system 20 stores beforehand the map which defines the relationship between the yaw moment instruction value and the rotation speed of the fluid pressure pump 20b, and it refers to the map to operate the fluid pressure pump 20b at a rotation speed corresponding to the set target yaw moment (yaw moment instruction value) (e.g., the rotation speed of the fluid pressure pump 20b is raised to the rotation speed corresponding to the braking force instruction value by increasing the supplying power to the fluid pressure pump 20b). In addition, the brake control system 20 stores beforehand, for example, the map which defines a relationship between the yaw moment instruction value and the valve opening of the valve unit 20c, and it refers to the map to control the valve unit 20c individually so that the valve opening corresponds to the yaw moment instruction value (e.g., increases an opening of the solenoid valve to an opening corresponding to the braking force instruction value by raising the supplying power to the solenoid valve) to adjust the braking force of each wheel.

### <Operation and Effects>

Next, operation and effects of the vehicle system according to this embodiment of the present disclosure are described.

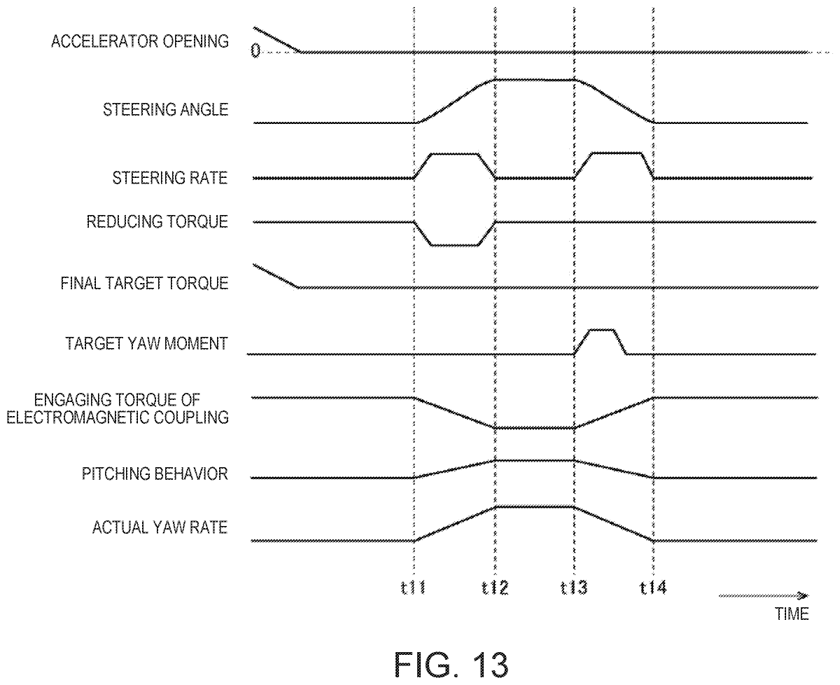

FIG. 13 illustrates one example of a time chart illustrating temporal changes in various parameters when executing the vehicle attitude control according to this embodiment of the present disclosure, while the vehicle 1 performs a turn-in, a normal turn, and a turn-out in this order. The time chart of FIG. 13 illustrates, in this order from top, the accelerator opening of the accelerator pedal, the steering angle of the steering wheel 6, the steering rate of the steering wheel 6, the torque reduction of the engine 4 set by the torque reduction setting (Step S12 of FIG. 5) of FIG. 6, a final target torque finally applied to the engine 4, the target yaw moment set by the target yaw moment setting (Step S13 of FIG. 5) of FIG. 8, the engaging torque (degree of engagement) of the electromagnetic coupling 5e, the pitching behavior of the vehicle 1, and the actual yaw rate of the vehicle 1. Note that the final target torque illustrated in FIG. 13 is a torque to which the torque reduction is applied to the target torque (Step S42 of FIG. 9) set based on the target acceleration and deceleration, and if the torque reduction is not set, the target torque becomes the final target torque as it is. Moreover, here, suppose that the target yaw moment has not been set by the skid prevention control (Step S15 of FIG. 5).

First, when the steering wheel 6 is steered forward, i.e., during the turn-in of the vehicle 1, the steering angle and the steering rate increase. As a result, at a time t11, the steering rate becomes the threshold S₁ or more (Step S22 of FIG. 6: Yes), and the torque reduction is set based on the additional deceleration according to the steering rate (Steps S23 and S24 of FIG. 6). In the example illustrated in FIG. 13, while the torque reduction is set, since the accelerator is OFF and the torque of the engine 4 is below the given value (Step S15 of FIG. 5: No), i.e., since the engine 4 is not in the state where the torque reduction can be realized, the final target torque obtained by reducing the torque reduction from the target torque is not set (in detail, the final target torque is about zero because the accelerator is OFF). That is, although the torque reduction is set, the second vehicle attitude control using this torque reduction is not executed.

Instead of the second vehicle attitude control not being executed because of the reason described above, the engaging torque of the electromagnetic coupling 5e is reduced according to the torque distribution setting of FIG. 9 during a period from the time t11 to a time t12. That is, according to the increase in the steering angle, the target yaw rate and the target lateral acceleration which are set become larger (see Step S44 of FIG. 9, and FIG. 10), and the first gain and the second gain which are set become smaller (see Steps S45 and S46 of FIG. 9, and FIG. 11). As a result, since the final distributed torque of the front wheels 2a to which the first gain or the second gain is applied decreases (Step S50 of FIG. 9), the engaging torque of the electromagnetic coupling 5e decreases. Since the torque distributed to the rear wheels 2b increases as the engaging torque of the electromagnetic coupling 5e decreases, the first vehicle attitude control for increasing the torque of the rear wheels 2b according to the steering forward of the steering wheel 6 is executed from the time t11 to the time t12. By such a first vehicle attitude control, the pitching in the forward-inclining direction is generated on the vehicle body 1a, and therefore, the response feel can be imparted to the driver during the turn-in of the vehicle 1.

Then, as the steering rate decreases during the first vehicle attitude control, the target yaw rate becomes below the given value or the target lateral acceleration becomes below the given value at the time t12 (Step S49 of FIG. 9: No), and the first vehicle attitude control is ended. In detail, the reduction in the engaging torque of the electromagnetic coupling 5e is stopped. Then, the steering angle becomes substantially constant from the time t12 to a time t13, and the vehicle 1 performs a normal turn. At this time, the engaging torque of the electromagnetic coupling 5e is maintained constant, and the pitching behavior of the vehicle 1 becomes constant (stable). Therefore, a grounding feel can be imparted to the driver during the normal turn of the vehicle 1.

Then, when the steering wheel 6 is steered in reverse, i.e., during the turn-out of the vehicle 1, the steering angle and the steering rate decrease. As a result, from the time t13 to a time t14, the engaging torque of the electromagnetic coupling 5e is increased according to the torque distribution setting of FIG. 9. That is, according to the reduction in the steering angle, the target yaw rate and the target lateral acceleration which are set become smaller (see Step S44 of FIG. 9, and FIG. 10). The first gain and the second gain which are set become larger (see Steps S45 and S46 of FIG. 9, and FIG. 11), and, as a result, since the final distributed torque of the front wheels 2a to which the first gain or the second gain is applied increases (Step S50 of FIG. 9), the engaging torque of the electromagnetic coupling 5e is increased. As the engaging torque of the electromagnetic coupling 5e is increased, since the torque distributed to the rear wheels 2b decreases, the third vehicle attitude control for reducing the torque of the rear wheels 2b according to the steering in reverse of the steering wheel 6 is executed from the time t13 to the time t14. By such a third vehicle attitude control, the pitching in the rearward-inclining direction is generated on the vehicle body 1a and the stable sensation can be imparted to the driver during the turn-out of the vehicle 1. Note that in the example illustrated in FIG. 13, since the change rate Δγ′ of the yaw rate difference is less than the threshold Y₂ during the steering in reverse of the steering wheel 6 (Step S47 of FIG. 9: No), the third vehicle attitude control is executed as described above, without executing the fourth vehicle attitude control.

On the other hand, during the steering in reverse of the steering wheel 6, the target yaw moment is set by the target yaw moment setting of FIG. 8 from the time t13 (Steps S34, S37, and S38 of FIG. 8). As a result, in addition to the third vehicle attitude control described above, the control (fifth vehicle attitude control) for applying the braking force to the turning outer wheel so that the yaw moment in the opposite direction of the yaw moment occurring on the vehicle 1 is applied to the vehicle 1 is executed. Therefore, the restorability from the turning is improved more effectively.

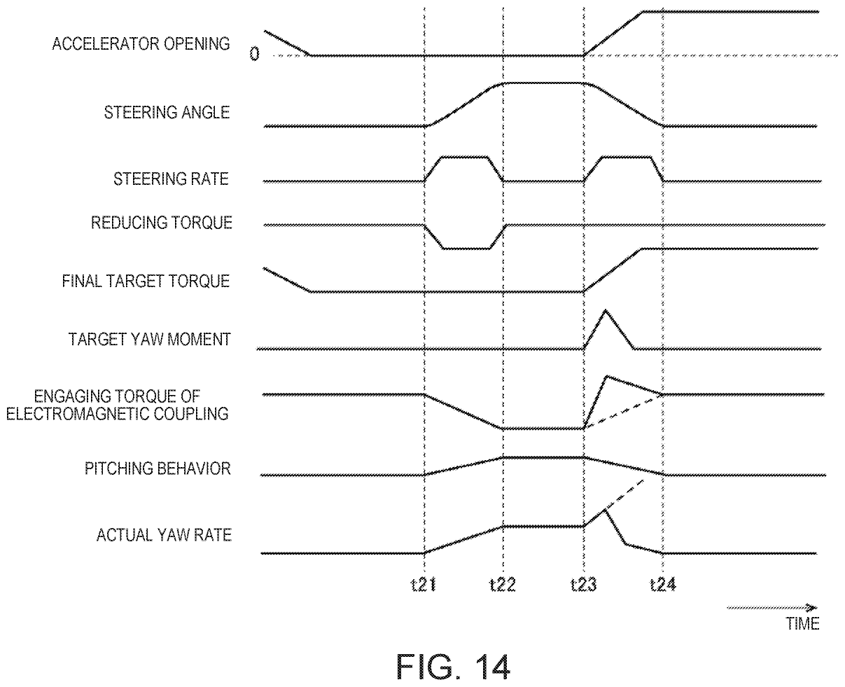

Next, FIG. 14 illustrates another example of the time chart illustrating the temporal changes in the various parameters when executing the vehicle attitude control according to this embodiment of the present disclosure, while the vehicle 1 performs the turn-in, the normal turn, and the turn-out in this order. Similar to FIG. 13, the time chart of FIG. 14 illustrates, sequentially from the top, the accelerator opening, the steering angle, the steering rate, the torque reduction, the final target torque, the target yaw moment, the engaging torque of the electromagnetic coupling 5e, the pitching behavior of the vehicle 1, and the actual yaw rate. Here, only differences from the time chart of FIG. 13 are described (unless otherwise particularly described, the same as FIG. 13).

In the example illustrated in FIG. 14, from a time t23, as a result of depressing the accelerator pedal while the steering wheel 6 is steered in reverse, the actual yaw rate increases rapidly. By such an increase in the actual yaw rate, since the change rate Δγ′ of the yaw rate difference during the steering in reverse of the steering wheel 6 becomes the threshold Y₂ or more (Step S47 of FIG. 9: Yes), the final distributed torque to the front wheels 2a is set larger (Step S48 of FIG. 9), and the engaging torque of the electromagnetic coupling 5e is increased greatly. That is, the fourth vehicle attitude control for reducing the torque of the rear wheels 2b greatly is executed from the time t23. In FIG. 14, graphs when the fourth vehicle attitude control is executed during the steering in reverse of the steering wheel 6 are illustrated by solid lines, and for a comparison with the graphs, graphs when the third vehicle attitude control described above is executed without executing the fourth vehicle attitude control are illustrated by broken lines (comparative example). As illustrated by the solid lines and broken lines, when the fourth vehicle attitude control is executed, the engaging torque of the electromagnetic coupling 5e is increased greatly and the torque of the rear wheels 2b is decreased greatly, more than when the third vehicle attitude control is executed. As a result, when the accelerator pedal is depressed during the steering in reverse of the steering wheel 6, the actual yaw rate (see broken line) continues increasing when the third vehicle attitude control is executed, but the increase in the actual yaw rate (see solid line) is prevented when the fourth vehicle attitude control is executed. That is, according to the fourth vehicle attitude control, even if the accelerator pedal is depressed during the steering in reverse of the steering wheel 6, the oversteer tendency of the vehicle 1 due to the slip of the rear wheels 2b is prevented appropriately.

Note that in the third vehicle attitude control, since the actual yaw rate continues increasing, when the fifth and/or sixth vehicle attitude control are executed in addition to the third vehicle attitude control, a comparatively large braking force is applied by the brake apparatus 20a so that a comparatively large yaw moment is applied to the vehicle 1. On the other hand, according to the fourth vehicle attitude control, since the increase in the actual yaw rate is prevented, such a large braking force is not applied. In detail, according to the fourth vehicle attitude control, the fifth vehicle attitude control tends to be executed fundamentally in addition to the fourth vehicle attitude control, but the braking force applied by the fifth vehicle attitude control can be reduced. Moreover, according to the fourth vehicle attitude control, the execution of the sixth vehicle attitude control (skid prevention control) is prevented, i.e., the application of the large braking force by the sixth vehicle attitude control is avoided. That is, according to the fourth vehicle attitude control, the interventions of the fifth and sixth vehicle attitude controls are prevented appropriately as compared with the third vehicle attitude control (a degree of intervention is prevented for the fifth vehicle attitude control, while the intervention of the control itself is prevented for the sixth vehicle attitude control).

As described above, according to this embodiment, the controller 50 controls the electromagnetic coupling 5e to reduce the torque distributed to the rear wheels 2b (fourth vehicle attitude control), when the change rate Δγ′ of the difference (yaw rate difference) between the target yaw rate and the actual yaw rate is the threshold Y₂ or more while the steering wheel 6 is steered in reverse. Thus, when the steering wheel 6 is steered in reverse, and for example, if the accelerator pedal is depressed, the slip of the rear wheels 2b can be prevented by exactly reducing the torque of the rear wheels 2b. As a result, when the steering wheel 6 is steered in reverse, it is prevented beforehand that the vehicle 1 tends to become the oversteer, and therefore, the stabilization of the vehicle posture is achieved.

Moreover, according to this embodiment, during the steering in reverse of the steering wheel 6, when the change rate Δγ′ of the yaw rate difference is the threshold Y₁ or more, the controller 50 executes the control for reducing the torque distributed to the rear wheels 2b by the electromagnetic coupling 5e as described above (fourth vehicle attitude control), while controlling the brake apparatus 20a to add the yaw moment in the opposite direction of the actual yaw rate to the vehicle 1 (fifth vehicle attitude control). Thus, the vehicle 1 is effectively prevented from a tendency to oversteer, and therefore, the restorability from the turning is effectively improved.

Moreover, according to this embodiment, the controller 50 controls the brake apparatus 20a to add the comparatively large yaw moment to the vehicle 1, when yaw rate difference Δγ is the threshold Y₃ or more (sixth vehicle attitude control). That is, even if the fourth vehicle attitude control is executed when the change rate Δγ′ of the yaw rate difference becomes the threshold Y₂ or more, and the fifth vehicle attitude control is executed when the change rate Δγ′ of the yaw rate difference becomes the threshold Y₁ or more, the controller 50 executes the sixth vehicle attitude control for adding the comparatively large yaw moment to the vehicle 1 when the skid of the vehicle 1 has occurred. Therefore, the skid of the vehicle 1 is certainly prevented.

Moreover, according to this embodiment, during the steering forward of the steering wheel 6, the controller 50 controls the electromagnetic coupling 5e to increase the torque of the rear wheels 2b (first vehicle attitude control) so that the pitching in the forward-inclining direction is generated on the vehicle body 1a (see FIG. 4A). By generating such a pitching in the forward-inclining direction on the vehicle body 1a, the response feel can be imparted to the driver during the turn-in, and the turning response of the vehicle 1 to the steering forward of the steering wheel 6 is improved. Moreover, according to this embodiment, during the steering in reverse of the steering wheel 6, the controller 50 controls the electromagnetic coupling 5e to reduce the torque of the rear wheels 2b (third vehicle attitude control) so that the pitching in the rearward-inclining direction is generated on the vehicle body 1a (see FIG. 4B). By generating such a pitching in the rearward-inclining direction on the vehicle body 1a, while a stable feel can be imparted to the driver during the turn-out, the vehicle response to the steering in reverse of the steering wheel 6, i.e., the restorability from the turning (restorability of the vehicle 1 to the straight-forward traveling state) is improved.

Moreover, according to this embodiment, during the steering in reverse of the steering wheel 6, the controller 50 makes the reducing amount of the torque distributed to the rear wheels 2b larger than when the change rate Δγ′ of the yaw rate difference is less than the threshold Y₂, when the change rate Δγ′ of the yaw rate difference is the threshold Y₂ or more. That is, the controller 50 executes the third vehicle attitude control when Δγ′ is less than the threshold Y₂, and executes the fourth vehicle attitude control for reducing the torque distributed to the rear wheels 2b more than the third vehicle attitude control when Δγ′ is the threshold Y₂ or more. Therefore, during the steering in reverse of the steering wheel 6, it is effectively prevented that the rear wheels 2b slips and the vehicle 1 tends to oversteer.

### <Modifications>

Although in the above embodiment the present disclosure is applied to the vehicle 1 which uses the engine 4 as the drive source, the present disclosure is also applicable to vehicles which use a drive source other than the engine 4. For example, the present disclosure is also applicable to vehicles which use a motor (electric motor) as the drive source.

Moreover, although in the above embodiment the yaw rate difference Δγ and the change rate Δγ′ of the yaw rate difference are illustrated as the yaw rate difference related values related to the difference between the target yaw rate and the actual yaw rate, the yaw rate difference related values may be defined based on a yaw acceleration, a lateral acceleration, a lateral jerk, etc., instead of defining the yaw rate difference related value based on the yaw rate.

Moreover, although in the above embodiment the electromagnetic coupling 5e is illustrated as the torque distribution mechanism for distributing the torque of the engine 4 to the front wheels 2a and the rear wheels 2b, various known mechanisms are also applicable as the torque distribution mechanism, without limiting to the electromagnetic coupling 5e.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims. Further, if used herein, the phrase “and/or” means either or both of two stated possibilities.

### DESCRIPTION OF REFERENCE CHARACTERS

1 Vehicle
2a Front Wheel
2b Rear Wheel
4 Engine
5a Transmission
5b Propeller Shaft
5d Transfer
5e Electromagnetic Coupling
5f Power Transmission Shaft
7 Steering Device
6 Steering Wheel
8 Steering Angle Sensor
10 Accelerator Opening Sensor
12 Vehicle Speed Sensor
50 Controller

What is claimed is:

1. A vehicle system, comprising:
a drive source configured to generate torque for driving a vehicle;
wheels including rear wheels that are primary driving wheels and front wheels that are auxiliary driving wheels;
a torque distribution mechanism configured to distribute the torque of the drive source to the front wheels and the rear wheels;
a steering wheel configured to be operated by a driver; and
a controller configured to control at least the torque distribution mechanism,
wherein when the steering wheel is steered in reverse and a yaw rate difference related value related to a difference between a target yaw rate to be generated on the vehicle according to the steering of the steering wheel and an actual yaw rate actually generated on the vehicle is greater than or equal to a first predetermined value, the controller controls the torque distribution mechanism to reduce the torque distributed to the rear wheels among the torque of the drive source.

2. The vehicle system of claim 1, further comprising a brake apparatus configured to apply a braking force to the wheels,
wherein when the yaw rate difference related value is greater than or equal to a second predetermined value that is larger than the first predetermined value, the controller controls the brake apparatus to apply a yaw moment in the opposite direction of the actual yaw rate to the vehicle.

3. The vehicle system of claim 2, wherein when the yaw rate difference related value is greater than or equal to a third predetermined value that is larger than the second predetermined value, the controller controls the brake apparatus to apply to the vehicle the yaw moment that is larger than that when the yaw rate difference related value is greater than or equal to the second predetermined value and less than the third predetermined value.

4. The vehicle system of claim 1, wherein the controller controls the torque distribution mechanism to:
when the steering wheel is steered forward, increase the torque distributed to the rear wheels;
when the steering wheel is then steered in reverse, reduce the torque distributed to the rear wheels; and
when the steering wheel is steered in reverse and the yaw rate difference related value is greater than or equal to the first predetermined value, increase a reducing amount of the torque distributed to the rear wheels more than that when the yaw rate difference related value is less than the first predetermined value.

5. The vehicle system of claim 1, wherein the yaw rate difference related value includes a rate of change in the difference between the target yaw rate and the actual yaw rate, and/or the difference between the target yaw rate and the actual yaw rate.
